(19) United States
(12) Patent Application Publication
(10) Pub. No.: US 2014/0193669 A1
(43) Pub. Date: Jul. 10, 2014

(54) BATTERY PACK

(71) Applicant: SAMSUNG SDI CO., LTD., Yongin-si (KR)

(72) Inventors: Hankyu Park, Yongin-si (KR); Inkyu Park, Yongin-si (KR)

(21) Appl. No.: 13/870,573

(22) Filed: Apr. 25, 2013

(30) Foreign Application Priority Data
Jan. 10, 2013 (KR) 10-2013-0003100

(51) Int. Cl. H01M 2/02; H01M 10/42

(52) U.S. Cl. CPC H01M 2/0217; H01M 10/4257
USPC 429/7; 429/176

(57) ABSTRACT

A battery pack including a case, which is improved by preventing deformation, such as warp, from occurring to the case, is provided. The battery pack includes one or more batteries, a protective circuit module (PCM) electrically connected to the batteries, a case accommodating the batteries and the PCM, and one or more warp preventing portions inserted into a frame forming the case and formed along the lengthwise direction of the case. Accordingly, it is possible to prevent the case of the battery pack from being warped or distorted.

### CLAIM OF PRIORITY

This application makes reference to, incorporates the same herein, and claims all benefits accruing under 35 U.S.C. §119 from an application earlier filed in the Korean Intellectual Property Office on 10 Jan. 2013 and there duly assigned Serial No. 10-2013-0003100.

### BACKGROUND OF THE INVENTION

1. Field of the Invention

Embodiments of the present invention relate to a battery pack, and more particularly, to a battery pack including a case with reinforced mechanical strength.

2. Description of the Related Art

In general, an electronic device, such as a notebook, a mini notebook, a net book, a mobile computer, an ultra mobile personal computer (UMPC), a portable multimedia player (PMP), or the like, uses a battery pack having multiple batteries connected in series/parallel as a portable power source. The battery pack includes a protective circuit module (PCM) for protecting batteries from overcharge, overdischarge or overcurrent, and the batteries and the PCM are incorporated into the battery pack together with a case.

In recent years, demand for a slimmer profile of a battery pack is increasing. To cope with the demand, components of a case are formed of thin films. However, during or after the case is manufactured, the case may be prone to deformation such as warp due to the reduction in its thickness.

### SUMMARY OF THE INVENTION

Embodiments of the present invention provide a battery pack including a case, which is improved by preventing deformation such as warp.

According to an embodiment of the present invention, a battery pack is provided. The battery pack includes one or more batteries, a protective circuit module (PCM) electrically connected to the batteries, a case accommodating the batteries and the PCM, and one or more warp preventing portions inserted into a frame forming the case and formed along the lengthwise direction of the case.

Each of the warp preventing portions may include a main body shaped of a bar and a hemming part formed by bending lengthwise opposite ends of the main body.

Each of the warp preventing portions may be positioned at the center of a bottom portion of the case.

The warp preventing portions may be main warp preventing portions and may further include sub warp preventing portions positioned at opposite ends of the bottom portion of the case, and each of the sub warp preventing portions may include a sub body shaped of a bar and a bent portion having one lengthwise end of the sub body bent.

Each of the warp preventing portions may be formed of a pipe compressed into a bar.

Each of the warp preventing portions may be positioned at the center of a bottom portion of the case.

The warp preventing portions may be main warp preventing portions and further include sub warp preventing portions positioned at opposite ends of the bottom portion of the case, and each of the sub warp preventing portions may include a sub body shaped of a bar and a bent portion having one lengthwise end of the sub body bent.

The warp preventing portions may include a main warp preventing portion positioned at the center of the bottom portion of the case and sub warp preventing portions positioned at opposite ends of the bottom portion of the case.

The main warp preventing portion may include a body shaped of a bar and a hemming part formed by bending lengthwise opposite ends of the body, and each of the sub warp preventing portions may be formed of a pipe compressed into a bar.

The main warp preventing portion may be formed of a pipe compressed into a bar and each of the sub warp preventing portions may include a body shaped of a bar and a hemming part formed by bending lengthwise opposite ends of the body.

The warp preventing portions may be positioned at opposite ends of the bottom portion of the case.

Each of the warp preventing portions may include a body shaped of a bar and a hemming part formed by bending lengthwise opposite ends of the body.

Each of the warp preventing portions is formed of a pipe compressed into a bar.

The warp preventing portions may include a first warp preventing portion and a second warp preventing portion, the first warp preventing portion includes a body shaped of a bar and a hemming part formed by bending lengthwise opposite ends of the body, and the second warp preventing portion is formed of a pipe compressed into a bar.

Each of the warp preventing portions may include a body shaped of a bar and a hemming part formed by bending lengthwise one end of the body.

The warp preventing portions may have a thickness in a range of 0.4 to 0.5 millimeter (or mm).

The warp preventing portions may include steel or stainless steel material.

According to another embodiment of the present invention, a case of a battery pack is provided, including a case body accommodating one or more batteries; and one or more warp preventing portions inserted into a bottom portion of the case body and formed along the lengthwise direction of the case body.

According to the present invention, it is possible to provide a battery pack including a case which is suppressed from deformation, such as warp.

Additional aspects and/or advantages of the invention will be set forth in part in the description which follows and, in part, will be obvious from the description, or may be learned by practice of the invention.

### BRIEF DESCRIPTION OF THE DRAWINGS

The objects, features and advantages of the present invention will be more apparent from the following detailed description in conjunction with the accompanying drawings, in which:

FIG. 1 is an oblique view illustrating a battery pack constructed as an embodiment according to the principles of the present invention;

FIG. 2 is an exploded oblique view illustrating the battery pack shown in FIG. 1;

FIGS. 3A through 3C are partially enlarged oblique views illustrating an ‘A’ portion of FIG. 2, showing various examples of structures of warp preventing portions; and

FIGS. 4A through 7D are cross-sectional views of cases having combinations of the warp preventing portions shown in FIGS. 3A through 3C.

### DETAILED DESCRIPTION OF THE INVENTION

Hereinafter, embodiments of the present invention will be described in detail with reference to the accompanying drawings.

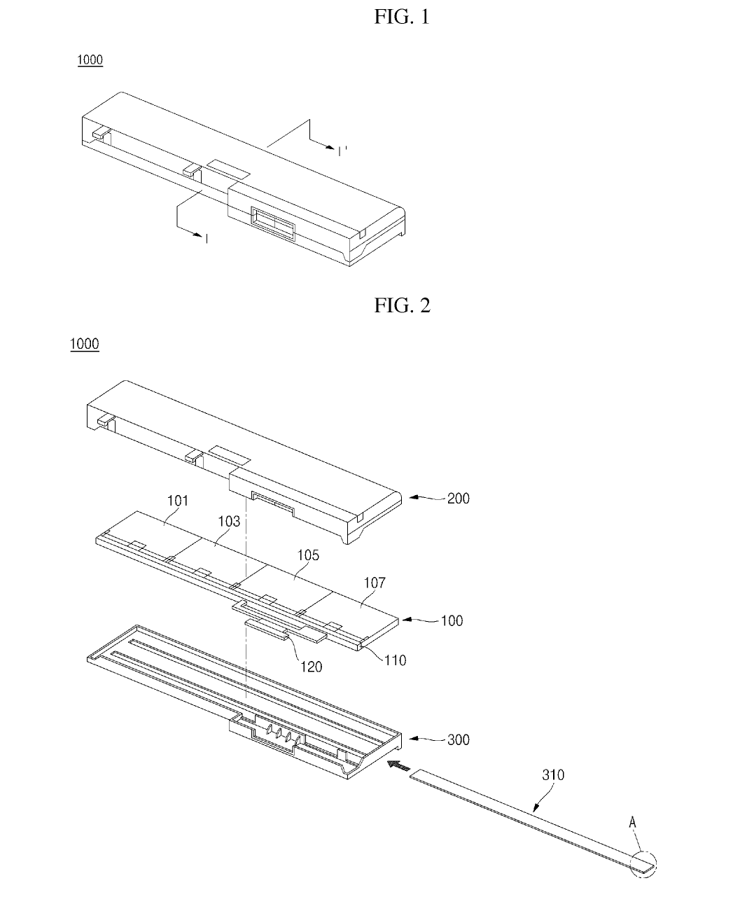

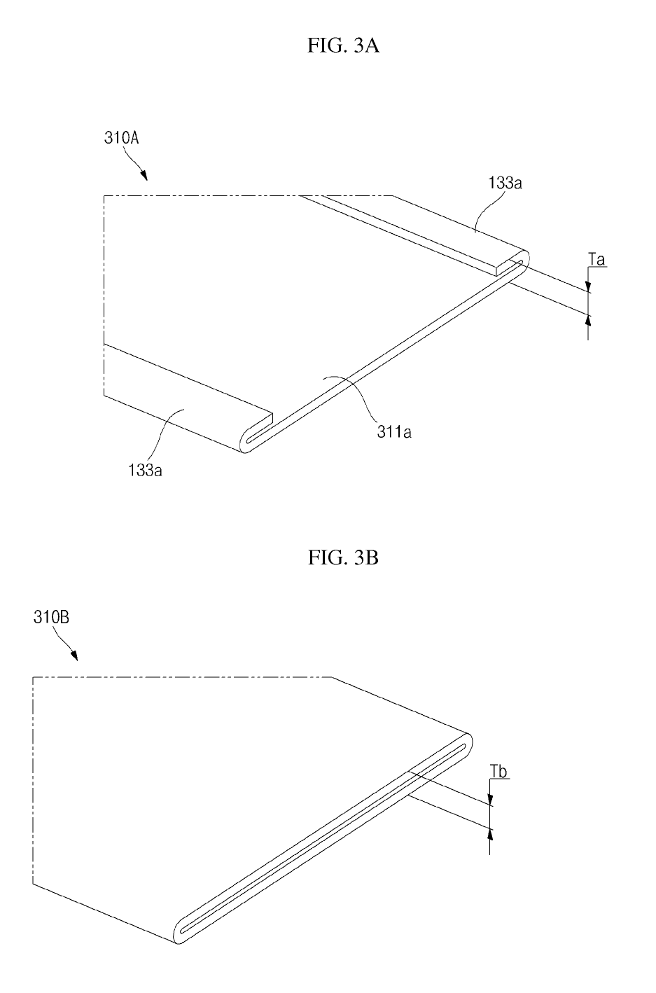

FIG. 1 is a perspective view illustrating a battery pack constructed as an embodiment according to the principles of the present invention. FIG. 2 is an exploded oblique view illustrating the battery pack shown in FIG. 1.

Referring to FIGS. 1 and 2, a battery pack 1000 constructed as an embodiment according to the principles of the present invention includes a battery module 100 and cases 200 and 300.

The battery module 100 may include a plurality of batteries 101, 103, 105 and 107 and a protective circuit module (PCM) 110 electrically connected to the plurality of batteries 101, 103, 105 and 107.

The plurality of batteries 101, 103, 105 and 107 may be connected to each other in series or in parallel. In addition, the plurality of batteries 101, 103, 105 and 107 may be connected to each other in a combination of series and parallel connections, such that some of the plurality of batteries 101, 103, 105 and 107 may be connected to each other in series and the other of the plurality of batteries 101, 103, 105 and 107 may be connected to each other in parallel. FIG. 2 shows 4 batteries 101, 103, 105 and 107, but aspects of the present invention are not limited thereto. The battery pack 1000 may include various numbers of batteries according to the specification of the battery pack 1000. In addition, FIG. 2 shows that four batteries 101, 103, 105 and 107 are horizontally arranged, but aspects of the present invention are not limited thereto. That is to say, the batteries 101, 103, 105 and 107 may be horizontally arranged, or some of the batteries 101, 103, 105 and 107 may be vertically and the others may be horizontally arranged. As described above, the present embodiment of the present invention does not limit the number and arrangement of batteries, and various modifications can be made.

The batteries 101, 103, 105 and 107 may be rechargeable pouch-type batteries, but aspects of the present invention are not limited thereto. The batteries 101, 103, 105 and 107 may be batteries of various shapes and types. Each of the batteries 101, 103, 105 and 107 may include an electrode tab (not shown) for electrical connection with the PCM 110. The electrode tab may include a positive electrode tab and a negative electrode tab. In addition, each of the batteries 101, 103, 105 and 107 may be implemented by a lithium-ion battery, but aspects of the present invention are not limited thereto. Each of the batteries 101, 103, 105 and 107 may be implemented by a nickel-cadmium battery, or a nickel metal hydride battery (NiMH).

The PCM 110, which is electrically connected to the plurality of batteries 101, 103, 105 and 107, collects state information concerning charge/discharge states or temperatures of the batteries 101, 103, 105 and 107, and controls charge/discharge operations of the batteries 101, 103, 105 and 107. The PCM 110 may be electrically connected to an external input/output terminal 120 for data communication with respect to an external circuit (not shown) or power supply with respect to an external power source (not shown) or an external load (not shown). A portion of the external input/output terminal 120 may be coupled to cases 200 and 300 to be exposed to the outsides of the cases 200 and 300.

The cases 200 and 300 may include an upper case 200 and a lower case 300. Each of the upper case 200 and the lower case 300 may have a plate-shaped bottom portion and sidewalls extending perpendicular to the bottom portion along edges of the bottom portion. The bottom portion of each of the upper case 200 and the lower case 300 may be shaped of a polygon. However, for the sake of convenient explanation, in the present embodiment, it is assumed that the bottom portion is substantially rectangular. It is also assumed that the rectangular bottom portion has a horizontal length and a vertical length and the vertical length is greater than the horizontal length. Accordingly, the cases 200 and 300 may be shaped of elongated cubes. Meanwhile, openings may be formed at corresponding locations of the sidewalls of the upper case 200 and the lower case 300. A portion of the external input/output terminal 120 may be exposed to the outside through the opening. The upper case 200 and the lower case 300 may cover the plurality of batteries 101, 103, 105 and 107, the PCM 110 and the external input/output terminal 120 from top and bottom sides, thereby accommodating the plurality of batteries 101, 103, 105 and 107, the PCM 110 and the external input/output terminal 120.

A frame forming the upper case 200 and the lower case 300 may have a thickness in a range of 0.8 to 1 millimeter (or mm). As described above, since the upper case 200 and the lower case 300 are formed to have a very small thickness and are elongated, the case has been conventionally prone to warp or distortion while or after the case is fabricated, resulting in deformation of the battery pack. However, in the embodiment of the present invention, the warp preventing portion 310 is formed in the upper case 200 and/or the lower case 300, thereby preventing warp or distortion of the case 200, 300.

The warp preventing portion 310 may be inserted into the frame forming the upper case 200 and/or lower case 300. More specifically, the warp preventing portion 310 may be inserted into the bottom portion of each of the upper case 200 and/or lower case 300. The warp preventing portion 310 may include steel or stainless steel material and may be formed into the frame of the upper case 200 and/or the lower case 300 by insert molding. In addition, the warp preventing portion 310 may be formed along the lengthwise directions of the upper case 200 and the lower case 300. Here, the lengthwise direction may mean a vertical direction of the bottom portion. The warp preventing portion 310 may be shaped of a substantially rectangular bar. A horizontal length (width) of the warp preventing portion 310 may be smaller than that of the bottom portion of each of the upper case 200 and the lower case 300, and a vertical length of the warp preventing portion 310 may be greater than that of the bottom portion of each of the upper case 200 and the lower case 300. The thickness of the warp preventing portion 310 may be smaller than that of the bottom portion of each of the upper case 200 and the lower case 300. For example, the bottom portion of each of the upper case 200 and the lower case 300 may have a thickness in a range of 0.8 to 1 millimeter (or mm), and the warp preventing portion 310 may have a thickness in a range of 0.4 to 0.5 millimeter (or mm).

Hereinafter, the structure of the warp preventing portion 310 according to the embodiment of the present invention will be described in more detail.

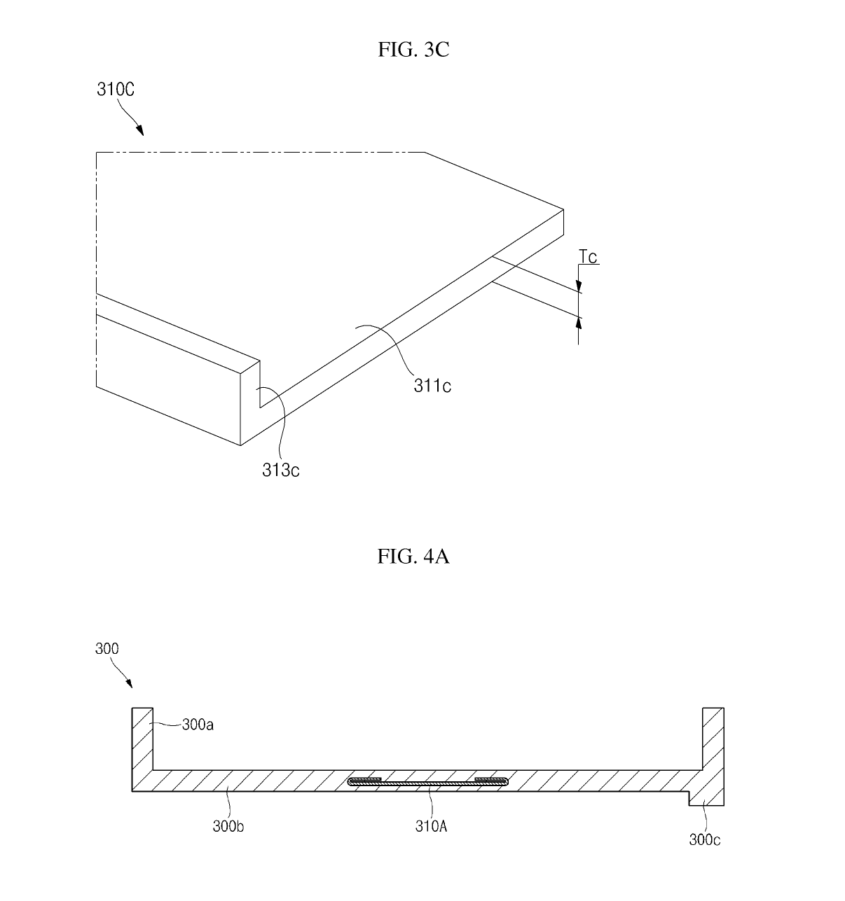

FIGS. 3A through 3C are partially enlarged oblique views illustrating an ‘A’ portion of FIG. 2, showing various examples of structures of warp preventing portions.

Specifically, FIG. 3A is a partially enlarged oblique view illustrating a hemming type warp preventing portion.

Referring to FIG. 3A, a hemming type warp preventing portion 310A may include a body 311a including steel or stainless steel material and a hemming part 133a. The body 311a may be shaped of a rectangular bar, providing the whole frame of the warp preventing portion 310A. The hemming part 133a may be a part formed by bending opposite ends of the body 311a and may reinforce a mechanical strength of the body 311a. Here, the opposite ends of the body 311a may be relatively long, facing ones of four ends of body 311a and may be parallel with the lengthwise direction of the bottom portion.

A thickness Ta of the hemming type warp preventing portion 310A is preferably smaller than the thickness of the bottom portion of each of the upper case 200 and the lower case 300. For example, when the thickness of the bottom portion of each of the upper case 200 and the lower case 300 is in a range of 0.8 to 1 millimeter (or mm), the thickness Ta of the hemming type warp preventing portion 310A may be in a range of 0.4 to 0.5 millimeter (or mm). However, the present invention does not limit the numerical value or range of thickness of the warp preventing portion 310A to those listed therein. Rather, the thickness of the warp preventing portion 310A may be appropriately changed in consideration of the material of the warp preventing portion 310A and the thickness of the bottom portion of each of the upper case 200 and the lower case 300 insofar as warp or distortion does not occur while or after the upper case 200 and the lower case 300 are fabricated.

Meanwhile, a space may be formed between the body 311a and the hemming part 133a, and during insert molding, resin may be injected into the space. Accordingly, the hemming type warp preventing portion 310A can be more securely coupled to the upper case 200 and/or the lower case 300.

FIG. 3B is a partially enlarged oblique view illustrating a pipe type warp preventing portion.

A pipe type warp preventing portion 310B shown in FIG. 3B may be shaped of a bar formed by compressing a pipe made of steel or stainless steel material.

The thickness Tb of the pipe type warp preventing portion 310B is preferably smaller than the thickness of the bottom portion of each of the upper case 200 and the lower case 300. For example, when the thickness of the bottom portion of each of the upper case 200 and the lower case 300 is in a range of 0.8 to 1 millimeter (or mm), the thickness Tb of the pipe type warp preventing portion 310B may be in a range of 0.4 to 0.5 millimeter (or mm). However, the present invention does not limit the numerical value or range of thickness of the warp preventing portion 310B to those listed therein. Rather, the thickness of the warp preventing portion 310B may be appropriately changed in consideration of the material of the warp preventing portion 310B and the thickness of the bottom portion of each of the upper case 200 and the lower case 300 insofar as warp or distortion does not occur while or after the upper case 200 and the lower case 300 are fabricated.

Meanwhile, a vacant space may be formed within the pipe type warp preventing portion 310B, and during insert molding, resin may be injected into the space. Accordingly, the pipe type warp preventing portion 310B can be more securely coupled to the upper case 200 and/or the lower case 300.

The pipe type warp preventing portion 310B can be employed when a higher level of strength than the hemming type warp preventing portion 310A is required.

FIG. 3C is a partially enlarged oblique view illustrating an L-type warp preventing portion.

Referring to FIG. 3C, an L-type warp preventing portion 310C may include a body 311c made of steel or stainless steel material and a bent portion 313c. The body 311c may be shaped of a rectangular bar, providing the whole frame of the warp preventing portion 310C. The bent portion 313c may be a part formed by bending one end of the body 311c and may be positioned within sidewalls of the upper case 200 and/or the lower case 300 and/or a protruding part. Here, the one end of the body 311c may mean a lengthwise end of the body 311c and may be parallel with a lengthwise direction of the bottom portion of each of the upper case 200 and the lower case 300. In addition, the protruding part may mean a line-shaped protrusion formed at edge portions of a side surface of the bottom portion along the lengthwise direction of the bottom portion and may be additionally provided according to the design structure of the case. The bent portion 313c is a part formed substantially perpendicular to the body 311c by bending one end of the body 311c, but aspects of the present invention are not limited thereto. The bending angle of the bent portion 313c may vary according to the position or direction of the protruding part.

The thickness Tc of the L-type warp preventing portion 310C is preferably smaller than the thickness of the bottom portion or sidewall of each of the upper case 200 and the lower case 300.

For example, when the thickness of the bottom portion of each of the upper case 200 and the lower case 300 is in a range of 0.8 to 1 millimeter (or mm), the thickness Tc of the L-type warp preventing portion 310C may be in a range of 0.4 to 0.5 millimeter (or mm). However, the present invention does not limit the numerical value or range of thickness of the warp preventing portion 310C to those listed therein. Rather, the thickness of the warp preventing portion 310C may be appropriately changed in consideration of the material of the warp preventing portion 310C and the thickness of the bottom portion of each of the upper case 200 and the lower case 300 insofar as warp or distortion does not occur while or after the upper case 200 and the lower case 300 are fabricated.

Preferably, the L-type warp preventing portion 310C is adaptively positioned at opposite ends of the upper case 200 and the lower case 300 according to design structures of the upper case 200 and the lower case 300.

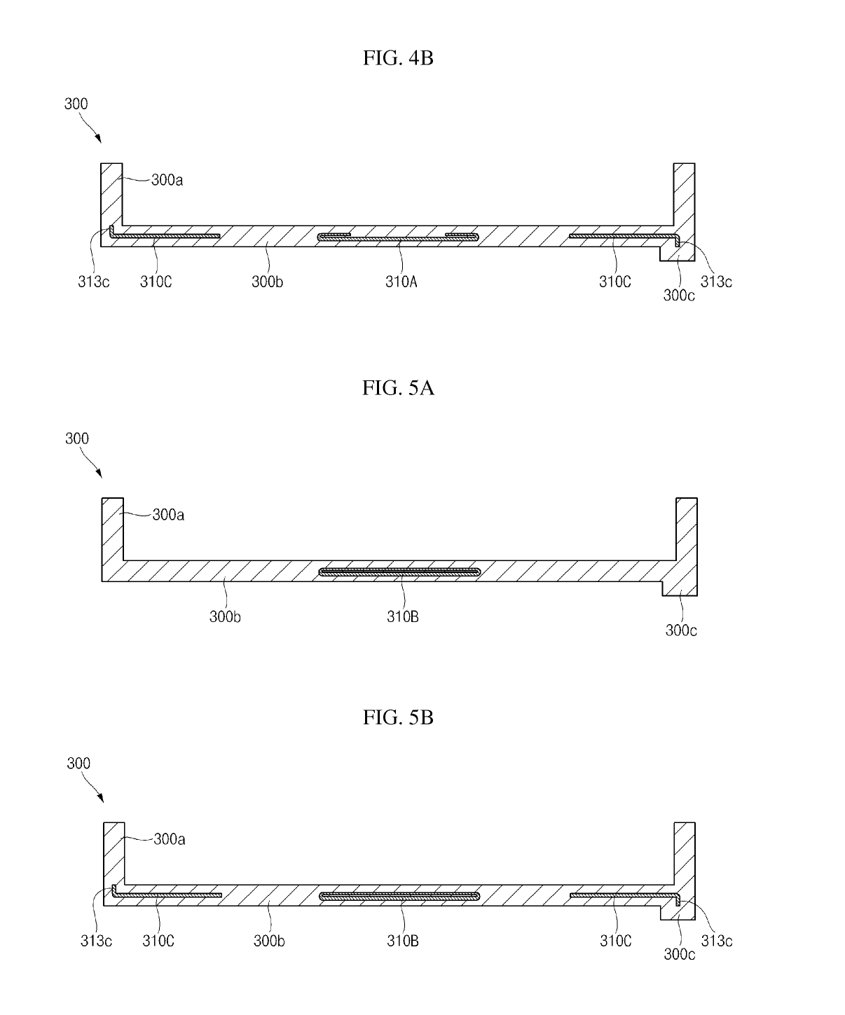

FIGS. 4A through 7D are cross-sectional views of lower cases having combinations of the warp preventing portions 310A, 310B, 310C shown in FIGS. 3A through 3C, taken along the line I-I′ of FIG. 1.

While only the lower case 300 is exemplified in FIGS. 4A through 7D, the same configurations and characteristics that follow may also apply to the upper case 200. In the following description, the expression ‘the center of bottom portion’ may mean a location passing the central axis of a bottom portion 300b of a lower case 300 extending lengthwise. In addition, the expression ‘opposite ends of bottom portion’ may mean opposite ends parallel with the lengthwise direction of the bottom portion 300b of a lower case 300. For a better understanding of the present embodiment, as described above, the hemming type warp preventing portion 310A, the pipe type warp preventing portion 310B, and the L-type warp preventing portions 310C will be separately described according to various types of the warp preventing portions.

FIG. 4A illustrates that the hemming type warp preventing portion 310A is formed only at the center of the bottom portion 300b of the lower case 300.

FIG. 4B illustrates that the hemming type warp preventing portion 310A is formed at the center of the bottom portion 300b of the lower case 300 and the L-type warp preventing portions 310C are formed at opposite ends of the bottom portion 300b. Here, the bent portion 313c of each of the L-type warp preventing portions 310C may be positioned in a sidewall 300a of the lower case 300 or in a protruding part 300c extending from the bottom portion 300b. In this case, the hemming type warp preventing portion 310A serves as a main warp preventing portion and the L-type warp preventing portions 310C serve as sub warp preventing portions. Therefore, a width of the hemming type warp preventing portion 310A may be greater than that of the L-type warp preventing portions 310C.

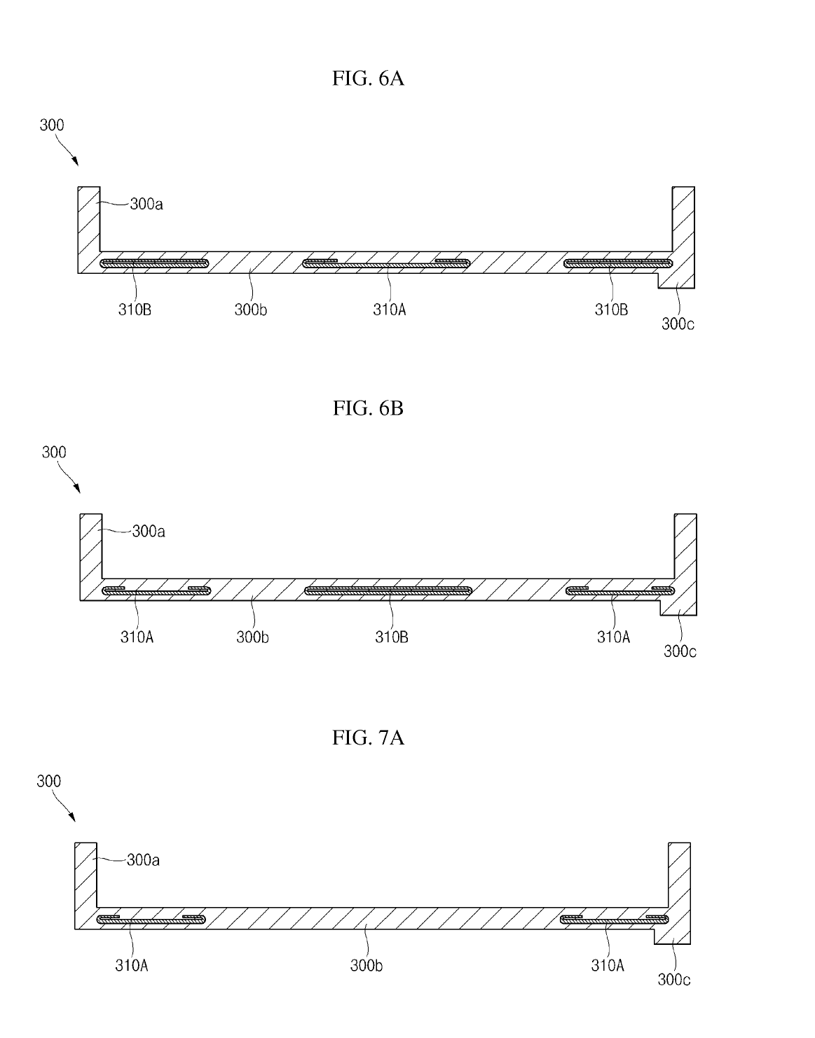

FIG. 5A illustrates that the pipe type warp preventing portion 310B is formed only at the center of the bottom portion 300b of the lower case 300.

FIG. 5B illustrates that the pipe type warp preventing portion 310B is formed at the center of the bottom portion 300b of the lower case 300 and L-type warp preventing portions 310C are formed at opposite ends of the bottom portion 300b. Here, the bent portion 313c of each of the L-type warp preventing portions 310C may be positioned in a sidewall 300a of the lower case 300 or in a protruding part 300c extending from the bottom portion 300b. In this case, the pipe type warp preventing portion 310B serves as a main warp preventing portion and the L-type warp preventing portions 310C serve as sub warp preventing portions. Therefore, a width of the pipe type warp preventing portion 310B may be greater than that of the L-type warp preventing portions 310C.

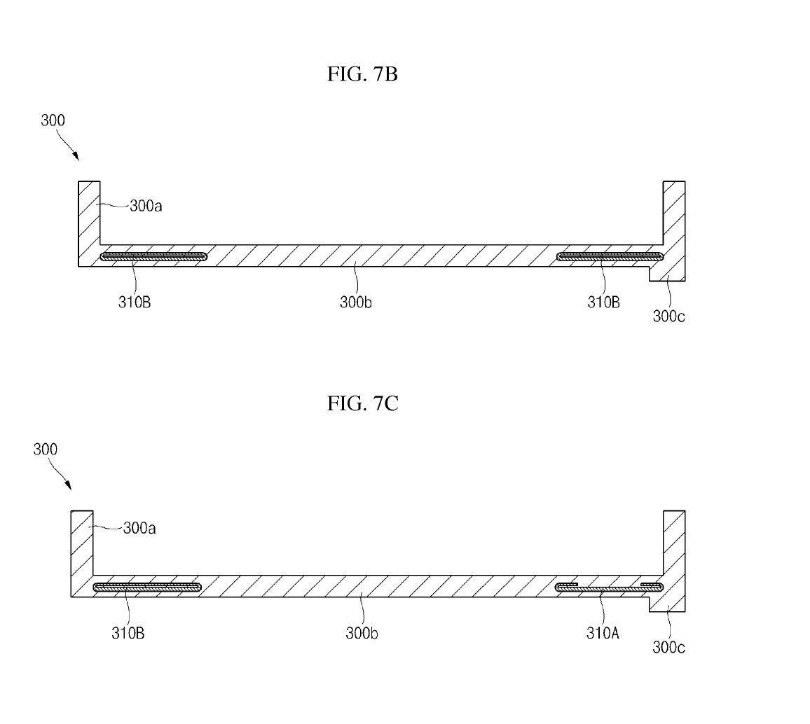

FIG. 6A illustrates that the hemming type warp preventing portion 310A is formed at the center of the bottom portion 300b of the lower case 300 and pipe type warp preventing portions 310B are formed at opposite ends of the bottom portion 300b. In this case, the hemming type warp preventing portion 310A serves as a main warp preventing portion and the pipe type warp preventing portions 310B serve as sub warp preventing portions. Therefore, a width of the hemming type warp preventing portion 310A may be greater than that of each of the pipe type warp preventing portions 310B.

FIG. 6B illustrates that the pipe type warp preventing portion 310B is formed at the center of the bottom portion 300b of the lower case 300 and hemming type warp preventing portions 310A are formed at opposite ends of the bottom portion 300b of the lower case 300. In this case, the pipe type warp preventing portion 310B serves as a main warp preventing portion and the hemming type warp preventing portions 310A serve as sub warp preventing portions. Therefore, a width of the pipe type warp preventing portion 310B may be greater than that of each of the hemming type warp preventing portions 310A.

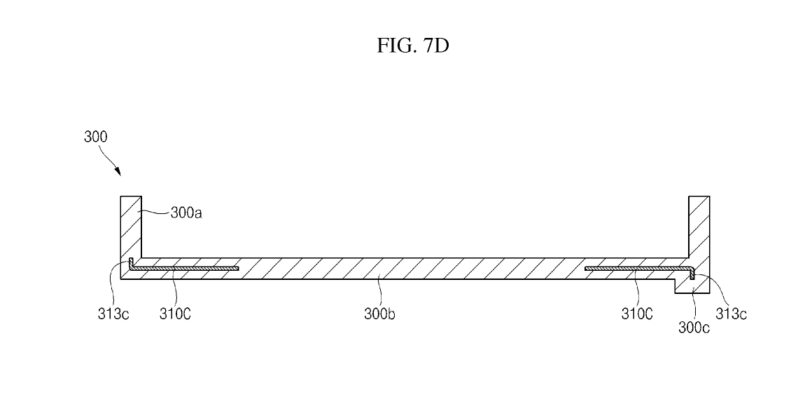

FIG. 7A illustrates that hemming type warp preventing portions 310A are formed only at opposite ends of the bottom portion 300b of the lower case 300.

FIG. 7B illustrates that pipe type warp preventing portions 310B are formed only at opposite ends of the bottom portion 300b of the lower case 300.

FIG. 7C illustrates that the pipe type warp preventing portion 310B is formed at one (the left handed side) of opposite ends of the bottom portion 300b of the lower case 300 and the hemming type warp preventing portion 310A is formed at the other (the right handed side) of opposite ends of the bottom portion 300b of the lower case 300.

FIG. 7D illustrates that the L-type warp preventing portions 310C are formed at only opposite ends of the bottom portion 300b of the lower case 300. Here, the bent portion 313c of each of the L-type warp preventing portions 310C may be positioned in a sidewall 300a of the lower case 300 or in a protruding part 300c extending from the bottom portion 300b.

As described above, according to various design structure of the case, various types of warp preventing portions can be formed in the case in combinations of appropriate positions and numbers.

According to the embodiment of the present invention, a mechanical strength of a case can be reinforced by forming warp preventing portions in the case, thereby preventing the case from warped or distorted.

While this invention has been described in connection with what is presently considered to be practical exemplary embodiments, it is to be understood that the invention is not limited to the disclosed embodiments, but, rather is intended to cover various modifications and equivalent arrangements included within the spirit and scope of the appended claims.

What is claimed is:

1. A battery pack, comprising:
one or more batteries;
a protective circuit module (PCM) electrically connected to the batteries;
a case accommodating the batteries and the PCM; and
one or more warp preventing portions inserted into a resin frame forming the case and formed along a lengthwise direction of the case.

2. The battery pack of claim 1, wherein each of the warp preventing portions includes a main body having a shape of a bar extending along the lengthwise direction and a hemming part formed by bending lengthwise opposite ends of the main body.

3. The battery pack of claim 2, wherein each of the warp preventing portions are positioned at a center of a bottom portion of the case.

4. The battery pack of claim 3, wherein the warp preventing portions are main warp preventing portions and further include sub warp preventing portions positioned at opposite ends of the bottom portion of the case, and each of the sub warp preventing portions includes a sub body having a shape of a bar and a bent portion having one lengthwise end of the sub body bent.

5. The battery pack of claim 1, wherein each of the warp preventing portions is formed of a pipe compressed into a bar.

6. The battery pack of claim 5, wherein each of the warp preventing portions are positioned at a center of a bottom portion of the case.

7. The battery pack of claim 6, wherein the warp preventing portions are main warp preventing portions and further include sub warp preventing portions positioned at opposite ends of the bottom portion of the case, and each of the sub warp preventing portions includes a sub body having a shape of a bar and a bent portion having one lengthwise end of the sub body bent.

8. The battery pack of claim 1, wherein the warp preventing portions include a main warp preventing portion positioned at a center of a bottom portion of the case, and sub warp preventing portions positioned at opposite ends of the bottom portion of the case.

9. The battery pack of claim 8, wherein the main warp preventing portion includes a body having a shape of a bar and a hemming part formed by bending lengthwise opposite ends of the body, and each of the sub warp preventing portions is formed from a pipe compressed into a bar.

10. The battery pack of claim 8, wherein the main warp preventing portion is formed of a pipe compressed into a bar and each of the sub warp preventing portions includes a body having a shape of a bar and a hemming part formed by bending lengthwise opposite ends of the body.

11. The battery pack of claim 1, wherein the warp preventing portions are positioned at opposite ends of the bottom portion of the case.

12. The battery pack of claim 11, wherein each of the warp preventing portions includes a body having a shape of a bar and a hemming part formed by bending lengthwise opposite ends of the body.

13. The battery pack of claim 11, wherein each of the warp preventing portions is formed of a pipe compressed into a bar.

14. The battery pack of claim 11, wherein the warp preventing portions include a first warp preventing portion and a second warp preventing portion, the first warp preventing portion includes a body having a shape of a bar and a hemming part formed by bending lengthwise opposite ends of the body, and the second warp preventing portion is formed of a pipe compressed into a bar.

15. The battery pack of claim 11, wherein each of the warp preventing portions includes a body having a shape of a bar and a hemming part formed by bending lengthwise one end of the body.

16. The battery pack of claim 1, wherein the warp preventing portions have a thickness in a range of 0.4 to 0.5 millimeter (or mm).

17. The battery pack of claim 1, wherein the warp preventing portions include steel or stainless steel material.

18. A case of a battery pack, comprising:
a case body accommodating one or more batteries; and
one or more warp preventing portions inserted into a bottom portion of the case body and formed along a lengthwise direction of the case body.
